(19) United States
(12) Patent Application Publication
(10) Pub. No.: US 2024/0011523 A1
(43) Pub. Date: Jan. 11, 2024

(54) Coupling Device for Articulated Connection of Two Elements of a Conveying and/or Sorting Device, and Corresponding Conveying and/or Sorting Device

(71) Applicant: Deutsche Post AG, Bonn (DE)

(72) Inventors: Wolfram GRAFE, Elmenhorst (DE); Bernd HARTMANN, Grafschaft-Leimersdorf (DE); Hillar LOH, Niederkassel (DE)

(21) Appl. No.: 18/474,799

(22) Filed: Sep. 26, 2023

Related U.S. Application Data
(63) Continuation of application No. 17/211,096, filed on Mar. 24, 2021.

(30) Foreign Application Priority Data
Mar. 26, 2020 (DE) 102020108418.8

(51) Int. Cl. F16C 11/04; B07C 99/00

(52) U.S. Cl. CPC F16C 11/04; B07C 99/00

(57) ABSTRACT

The invention concerns a coupling device for articulated connection of two elements of a device for conveying and/or sorting piece goods, wherein the coupling device connects together an end of each of the two elements pivotably with respect to a rotational axis in a plane to both sides, and the two ends lie diametrically opposite each other in a neutral position. It is provided that the coupling device is configured such that, starting from a respective central axis of the two ends, the rotational axis on a pivot movement in the direction of the one side lies on this one side of the central axes, and on a pivot movement in the direction of the other side lies on this other side of the respective central axis. The invention furthermore concerns a corresponding device for conveying and/or sorting piece goods.

### TECHNICAL FIELD

The invention concerns a coupling device for articulated connection of two elements of a device for conveying and/or sorting piece goods, wherein the coupling device connects together an end of each of the two elements pivotably with respect to at least one rotational axis in a plane to both sides, and the two ends lie diametrically opposite each other in a neutral position.

The invention furthermore concerns a device for conveying and/or sorting piece goods, with several elements for handling the piece goods and at least one coupling device which pivotably connects together a respective two of the series-arranged elements.

### BACKGROUND OF THE INVENTION

Such a device for conveying and/or sorting piece goods is for example a so-called sorter, such as a circular sorter. Such circular sorters are composed of series-arranged elements or trays for the individual piece goods, which run on a predefined track guided by rails in a similar fashion to a chain. These elements of the sorter are known as cells or sorting cells. In order to allow the elements to pass around curves, they must have a spacing which corresponds to the curve radius, so that the inner corners of corresponding elements do not collide with one another when travelling around a curve. For this, the individual elements are connected by means of coupling devices (also called couplings) which are arranged centrally on the cells in order to guarantee by their length the necessary spacing between the individual cells.

Conversely, this means that the spacing between adjacent elements is required only when passing around corresponding curves. On straight segments of a sorter, this spacing is not required. Since the level of possible sorting performance is determined not only by the speed of the sorter but also by the number of sorting elements relative to the sorting length, it is possible to shorten the coupling devices and hence increase the number of elements for the same sorter dimensions.

Publication DE 10 2016 104 943 A1 discloses a device for sorting piece goods, i.e. a sorter, with several sorting elements and at least one coupling device which pivotably connects together a respective two of the series-arranged elements. The coupling device is configured as a type of hinged coupling with two pivotably connected coupling parts which are attached to the corresponding ends of the elements.

### DESCRIPTION OF THE INVENTION

Starting from this situation, it is an object of the present invention to indicate measures which allow even relatively closely packed elements of a device for conveying and/or sorting piece goods to be guided on curved tracks.

The object of the invention is achieved by the features of the independent claims. Advantageous embodiments are given in the subclaims.

Accordingly, the object is achieved by a coupling device for articulated connection of two elements of a device for conveying and/or sorting piece goods, wherein the coupling device connects together an end of each of the two elements pivotably with respect to a rotational axis in a plane to both sides, and the two ends lie diametrically opposite each other in a neutral position, wherein the coupling device is configured such that, starting from a respective central axis of the two ends, the rotational axis on a pivot movement in the direction of the one side lies on this one side of the central axes, and on a pivot movement in the direction of the other side lies on this other side of the respective central axis. In this way, it is guaranteed that the corresponding elements can be guided around tightly curved tracks even with a relatively short coupling device. In particular, it is provided that the pivot movement of the coupling device always takes place about only one rotational axis. Often in such a coupling device, in the neutral position, the position of the rotational axis is not definitively established since the position of the rotational axis changes momentarily from the one side to the other, depending on the side on which the pivot movement takes place.

It is therefore an essential point of the invention that the position of the rotational axis for the pivot movement to the one side is different from the position of the rotational axis for the pivot movement to the other side, wherein the respective position of the rotational axis lies on the side in whose direction the pivot movement actually occurs, i.e. a corresponding kink movement.

According to a preferred embodiment of the invention, it is provided that the coupling device is configured, for the different positions of the rotational axis,
(a) to select these from two or more than two predefined positions, or
(b) to adjust these by shifting the rotational axis.

With alternative (a), usually a sudden change occurs between the predefined axis positions, whereas in alternative (b), a continuous shift of the current position of the rotational axis occurs.

According to a further preferred embodiment of the invention, it is provided that the coupling device has two coupling elements which have identical lengths and are pivotable in opposite directions. These are pivotably connected to each of the two ends of the elements, wherein the corresponding joints have a spacing at the respective end which corresponds to the length of the coupling elements.

In particular, it is provided that the coupling device is configured to form, with the two ends of the element, a four-bar linkage. A four-bar linkage is usually described by two bearings with hinges of defined position, and three bars connected together pivotably via two further hinges, giving a four-bar coupling system with four rotary hinges. For use inside the coupling device, taking the image of the four-bar linkage, the respective lengths of the bars of the linkage and the spacing between the two bearings are all equal. Accordingly, when used within the coupling device, the four-bar linkage does not operate in the usual fashion as a crank arm, double arm or double crank, but such that each mounted bar runs parallel to the arrangement of the bearings, and the other two bars, i.e. the respective other mounted bar and the bar of the linkage formed by the other element, pivot parallel to each other optionally about the one or the other bearing. These may then be described as coupling elements which have identical lengths and can pivot in opposite directions.

Alternatively, it is provided that the coupling device comprises flexible coupling elements which connect the two elements pivotably together. This mechanism is known from a Jacob's ladder toy. The flexible coupling elements are in particular formed as straps. They run crosswise between the ends of the elements. In top view, this forms an intersection point which marks the corresponding rotational axis for the pivot movement of the coupling device. This rotational axis is displaceable, so that with this embodiment of the coupling device, the different positions of the rotational axis can be adjusted by shifting the rotational axis along the gap between the ends. For use with said successive coupling of elements or trays, chains, cables, straps or belts may be used.

According to another alternative embodiment of the invention, it is provided that the coupling device has or is formed as a double hinge in the manner of a swing door hinge. A swing door hinge or swing door strap has two spring-loaded straps and allows swing doors to pivot in both passage directions. Such doors are known for example as saloon doors familiar from Westerns. In this way, the position of the rotational axis for the pivot movement can be changed from the one side to the other.

According to yet a further preferred embodiment of the invention, it is provided that the spacing between the two elements when the two elements are moved out of the neutral position is determined only by components of the coupling device lying on the currently used rotational axis.

Furthermore, advantageously it is provided that the spacing A of the positions of the rotational axis on a pivot movement to the one side and to the other side is greater than the length 1 of the coupling device which determines the spacing between the ends of the corresponding elements.

The object of the invention cited initially is furthermore achieved by a device for conveying and/or sorting piece goods with (i) several elements for handling the piece goods, and (ii) at least one coupling device which pivotably connects together a respective two of the series-arranged elements. It is provided here that the coupling device or at least one of the coupling devices, preferably all coupling devices, is/are configured as a coupling device as described above.

According to a preferred embodiment of the device according to the invention, it is provided that the width of the elements substantially corresponds to the spacing A of the different positions of the rotational axis. The position of the rotational axis therefore lies at a corner point on the side towards which the pivot movement is currently taking place.

According to a further preferred embodiment of the device according to the invention, it is provided that the device is configured as a sorter and/or distribution device known as a sorter. The following types of sorter are known: tilt tray sorter, belt tray sorter, sliding shoe sorter, drop flap sorter, comb sorter, helix sorter, circular sorter or ring sorter, and pocket sorter. Particular preferably, the device is configured as a circular sorter.

### BRIEF DESCRIPTION OF THE DRAWINGS

The invention is described in more detail below with reference to the appended drawings showing preferred exemplary embodiments.

The drawings show:

FIG. 1 a top view of a series of mutually coupled elements of a device for conveying and/or sorting piece goods according to a preferred exemplary embodiment of the invention,

FIG. 2 two elements of the device, and a coupling device pivotably connecting the two elements, according to a preferred embodiment of the invention,

FIG. 3 a top view of a series of mutually coupled elements of the device for conveying and/or sorting piece goods according to a further preferred exemplary embodiment of the invention, and

FIG. 4 a top view of a series of mutually coupled elements of the device for conveying and/or sorting piece goods according to a further preferred exemplary embodiment of the invention.

### DETAILED DESCRIPTION OF THE EXEMPLARY EMBODIMENTS

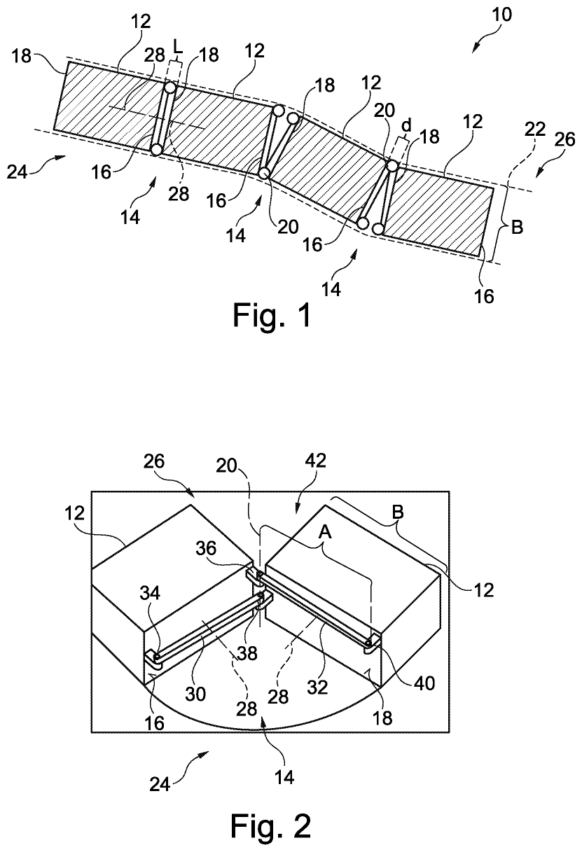

FIG. 1 shows a top view of essential parts of a device 10 for conveying and/or sorting piece goods (not shown), namely their elements 12 for handling the piece goods and corresponding coupling devices 14 for articulated mutual connection of the series-arranged elements 12. The coupling devices 14 are here arranged between the mutually opposing ends 16, 18 of two elements 12 arranged one directly behind the other, and connect these pivotably relative to a respective rotational axis 20. The two ends 16, 18 lie diametrically opposite one another in a neutral position of the articulated connection. This situation is shown in the two elements 12 on the left side of FIG. 1.

The device 10 in this example is a sorting and/or distribution device known as a sorter. In such a device 10, the series-arranged elements 12 for handling the piece goods are moved on a track 22 guided by rails (corresponding to the depicted markings of the track 22), wherein the track 22 lies in one plane and has corners. In other words, the series arrangement of the elements 12 is guided on the track 22 on both sides, i.e. on both sides 24, 26. The elements 12 are here arranged very close together in series, and the coupling devices 14 are correspondingly short. Such a coupling device 14 is therefore described as a short coupling.

In order to be able to guide the elements 12 in this close succession around the corners, the coupling device 14 is configured such that, starting from a theoretical respective central axis 28 of the two elements 12, the rotational axis 20 on a pivot movement of the coupling device 14 in the direction of the one side 24 lies on this one side 24 of the respective central axis, and on a pivot movement of the coupling device 14 in the direction of the opposite other side 26 lies on this other side 26 of the respective central axis 24. The coupling device 14 thus forms a kind of change-over hinge, in which the position of the corresponding rotational axis 20 of this change-over hinge—i.e. the hinge axis—always lies on the side 24, 26 into which the corner points and the pivot movement provoked by the corner takes place. In the example shown here, there are precisely two predefined positions of the rotational axis 20, namely one on the one side 24 and one on the other side 26. In the present example, the rotational axis 20 for the two elements 12 lies in the middle on the one side 24, and on the other side 26 for the two elements on the right side of FIG. 1. For the two elements 12 on the left side of FIG. 1, the ends 16, 18 of which lie precisely diametrically opposed, in this present situation there is no unique position of the rotational axis 20.

FIG. 2 shows the ends of two elements 12 of the device 10 shown in FIG. 1, and the coupling device 14 pivotably connecting these two elements 12 together. The coupling device 14 has two coupling elements 30, 32 which have an identical length and are pivotable in opposite directions, and which are connected pivotably via a respective first hinge 34, 36 to the end 16 of the one element 12 and via a respective second hinge 38, 40 to the end 18 of the other element 12. When the ends 16, 18 of the two elements 12 lie diametrically opposite each other, the two coupling elements 30, 32 are arranged parallel such that the first hinge 34 connected to the first end 16 is arranged aligned with the second hinge 40 connected to the second end 18 with respect to the first possible rotational axis position, and the second hinge 36 connected to the first end 16 is arranged aligned with the first hinge 38 connected to the second end 18 with respect to the second possible rotational axis position. In other words, the two coupling elements 30, 32 with the two ends 16, 18 of the elements 12 form a four-bar linkage 42. Four-bar linkages are known in connection with coupler mechanisms. Via the four-bar linkage 42 described here, a two-piece mechanism trajectory is generated in which the two parts of the mechanism trajectory correspond to the opposing pivot movements of the coupling elements 30, 32. In this way, it is possible to select the different positions of the rotational axis 20 from two predefined positions, so as to create the change-over hinge described in connection with FIG. 1. In the case shown in FIG. 2, the change-over hinge has moved in the direction of the other side 26, and accordingly the rotational axis 20 for the two elements 12 lies on the other side 26.

In this depiction, it is furthermore clearly evident that the width B of the elements 12 substantially corresponds to the spacing A of the different positions of the rotational axis 20, i.e. in this embodiment of the coupling device 14, the spacing of the hinges 34, 38; 36, 40 at the respective ends of one of the coupling elements 30, 32.

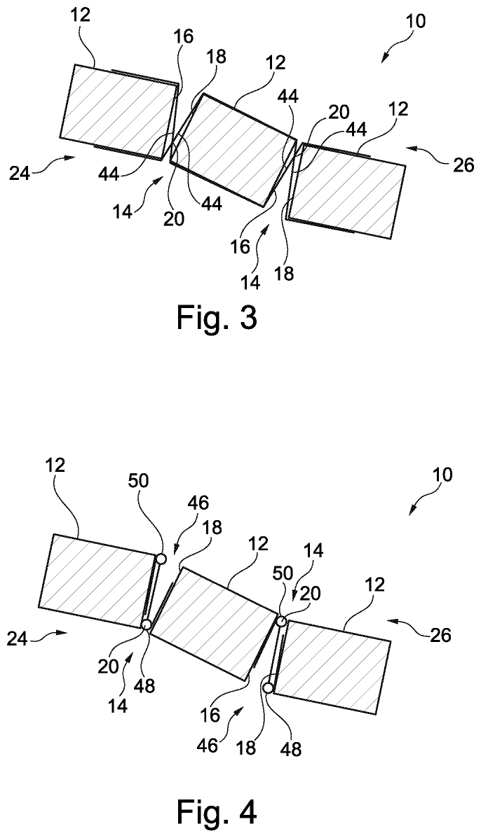

FIG. 3 shows a top view of a series of mutually coupled elements 12 of the device 10 for conveying and/or sorting piece goods, in which the coupling devices 14 have an alternative design. Each of the coupling devices comprises flexible coupling elements 44 which pivotably connect two respective elements 12. This mechanism is known from a Jacob's ladder toy. The flexible coupling elements 44 are here configured as straps. They run crosswise between the ends 16, 18 of the elements 12. In top view, an intersection point is formed which marks the corresponding rotational axis 20 for the pivot movement of the coupling device 14. This rotational axis 20 is displaceable so that, in this embodiment of the coupling device 14, the different positions of the rotational axis 20 can be adjusted by displacing the rotational axis 20 along the gap between the ends 16, 18.

In the embodiments of the coupling device 14 shown in FIGS. 1 to 3, the latter comprise at least two tension-stable coupling elements 30, 32, 44, wherein alternately their one end is connected to the first and their other end to the opposite second element 12. The coupling elements 30, 32, 44 may be configured as coupling rods, traction cables or belts.

Several mutually coupled elements 12 may form an autonomous assembly in the manner shown. The individual elements 12 are here guided so that they cannot rotate about their vertical axis. However, the assembly can be stretched out. The corresponding guides are known in the prior art and are used in known sorters with successively arranged elements 12. The minimum radii—minimized by the design principle—during a motorized relative movement of the elements 12 enable such an assembly to advance along curvo-linear routes. In straight line portions, the adjacent elements 12 thus lie close together; in curved portions, they twist horizontally relative to each other via the rotational axes 20 with changing positions.

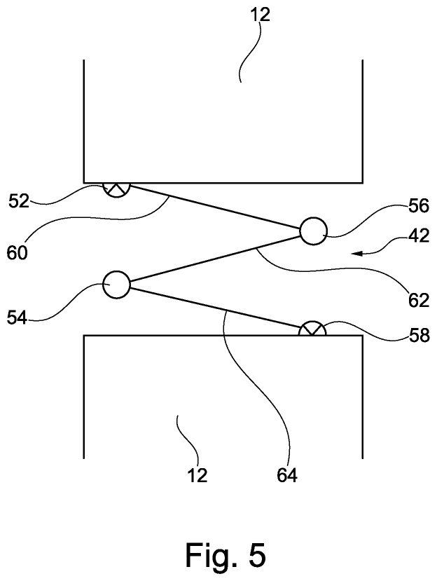

FIG. 4 finally shows a top view of a series of mutually coupled elements 12 of the device 10 for conveying and/or sorting piece goods, in which the coupling devices 14 are configured according to a totally different alternative. Each of the coupling devices has or is configured as a double hinge 46 in the form of a swing door hinge. A swing door hinge or swing door strap has two spring-loaded hinges 48, 50, and allows swing doors to swing in both passage directions. Such doors are known for example as saloon doors. In side view, the double hinge 46 has a Z-shape in the manner of a swing door hinge, wherein the spring loading forces this Z-shape into a folded position. The one or the other outer arm of the Z-shape can then be pivoted out of the folded position against the spring force. In this manner too, the position of the rotational axis 20 for the pivot movement may be changed from the one side 24 to the other 26.

The exemplary embodiments described are merely examples which may be modified and/or supplemented in many ways within the scope of the claims. Each feature described for a specific exemplary embodiment may be used independently or in combination with other features in any other exemplary embodiment. Each feature described for an exemplary embodiment of a specific category may also be used accordingly in an exemplary embodiment of another category.

### LIST OF REFERENCE SIGNS

Device for conveying and/or sorting 10
Elements 12
Coupling device 14
End 16
End 18
Rotational axis 20
Track 22
One side 24
Other side 26
Central axis (end) 28
Coupling element 30
Other coupling element 32
Hinge 34
Hinge 36
Hinge 38
Hinge 40
Four-bar linkage 42
Flexible coupling element 44
Double hinge 46
Spring-loaded hinge 48
Spring-loaded hinge 50
Spacing of rotational axis positions A
Width of elements B
Minimum spacing of adjacent elements d
Length of coupling device l

1-11. (canceled)

12. A device for conveying and/or sorting piece goods comprising:
several elements for handling the piece goods; and
at least one coupling device pivotably connecting together a respective two of a series of arranged elements,
wherein the coupling device connects together an end of each of the two elements pivotably with respect to at least one rotational axis in a plane to both ends, and the two ends lie diametrically opposite each other in a neutral position, wherein the coupling device is configured such that, starting from a respective central axis of the two ends, the at least one rotational axis on a pivot movement in a direction of one side lies on the one side of the respective central axis, and on a pivot movement in a direction of an other side lies on the other side of the respective central axis, and
wherein the coupling device is configured to form, with the two ends of the two elements, a four-bar linkage comprising two bearings with hinges of defined position, and three bars connected together pivotably via two further hinges.

13. A device according to claim 12, wherein the coupling device is configured, for different positions of the at least one rotational axis:
to select the different positions from two or more than two predefined positions, or
to adjust the different positions by shifting the at least one rotational axis.

14. A device according to claim 12, wherein the coupling device has two coupling elements which have identical lengths and are pivotable in opposite directions.

15. A device according to claim 12, wherein the coupling device is configured such that a spacing of the two elements when the two elements are moved out of the neutral position is determined only by components of the coupling device lying on the at least one rotational axis.

16. A device according to claim 12, wherein a spacing of-positions of the at least one rotational axis on a pivot movement to one side and to an other side is greater than a length of the coupling device which determines a spacing between the two ends of the two elements.

17. A device according to claim 12, wherein a width of the series-arranged elements substantially corresponds to a spacing of different positions of the at least one rotational axis.

18. A device according to claim 12, wherein the device is configured as a sorter.
